(19) United States
(12) Patent Application Publication
(10) Pub. No.: US 2025/0349936 A1
(43) Pub. Date: Nov. 13, 2025

(54) BATTERY HOLDER WITH COOLING SYSTEM

(71) Applicant: CAILLAU, ROMORANTIN-LANTHENAY (FR)

(72) Inventors: Quentin MINET, VILLENTROIS (FR); Benjamin DA CUNHA, ROMORANTIN (FR); Kévin MARCHAL, AUBIGNY SUR NERE (FR)

(21) Appl. No.: 19/100,599

(22) PCT Filed: Jun. 23, 2023
(86) PCT No.: PCT/FR2023/050954

§ 371 Date: Feb. 3, 2025

(30) Foreign Application Priority Data
Aug. 4, 2022 (FR) FR2208103

(51) Int. Cl. H01M 10/6568; B60R 16/04; H01M 10/613; H01M 10/625; H01M 10/6554

(52) U.S. Cl. CPC H01M 10/6568; B60R 16/04; H01M 10/613; H01M 10/625; H01M 10/6554; H01M 2220/20

(57) ABSTRACT

The cooling system comprises at least a cooling wall and a tube for circulating a coolant. The tube is held against the cooling wall by being disposed between this cooling wall and a fixing plate fixed to this wall, particularly by clinching.

### TECHNICAL FIELD

The disclosure relates to a battery holder comprising a cooling system.

### BACKGROUND

Battery holders may be a casing part containing a battery or battery units or cells. For example, the battery holder may be or comprise a wall or part of a wall against which a battery or battery cells are intended to rest.

It is known that a battery or battery cells need to be cooled to avoid overheating phenomena. For this purpose, it is known to fix a cooling tube on a battery holder wall. For example, the cooling tube is made in the form of one or more coils in which coolant circulates. The tube is for example fixed to the wall by welding. The fixing of the tube to the wall can be a source of fragility.

It is also known to make a cooling coil directly in a base sheet, by deformations of this sheet generally forming a coiled channel, and to close this channel using a lid sheet fixed to the one in which the channel is formed, so that the two sheets thus fixed form a battery holder wall. However, this requires great accuracy in fixing the lid on the base sheet and special precautions must be taken to maintain the sealing of this fixing and the correct circulation of the coolant in the channel formed between the two sheets. The fixing between these sheets is generally carried out by welding, which poses technical difficulties when making this fixing and problems of degradation over time harming the sealing.

It is also known, from document DE 10 2010 013 025, to add a coil-shaped tube under a sheet, the latter being provided with hollow deformations on its lower face to accommodate this coil, for example in a form-fitting manner. Sheet manufacture requires certain accuracy. The assembly with the tube is difficult to make and the fixing of the tube to the wall can be fragile.

### SUMMARY

The disclosure aims to overcome at least substantially the aforementioned drawbacks, while promoting the proper cooling of the holder.

Thus, the present disclosure relates to a battery holder comprising a cooling system that comprises at least a cooling wall and a tube for circulating a coolant, in which the tube is held against the cooling wall by being disposed between the cooling wall and a fixing plate fixed to said wall.

Optionally, the fixing plate is fixed to the cooling wall by clinching.

Optionally, the tube has at least one flattened face turned towards the cooling wall and/or the fixing plate.

Optionally, the tube has at least one contact face, in heat exchanging contact with the cooling wall, said contact face being optionally a flattened face.

Optionally, at least one of the elements comprising the cooling wall and the fixing plate has a relief for wedging the tube.

Optionally, at least one of the elements comprises the cooling wall and the fixing plate has at least one groove for receiving the tube.

Optionally, the fixing plate is fixed to the cooling wall in several fixing areas in which the fixing plate and the cooling wall are in contact, the fixing areas optionally comprising fixing areas located between portions of the tube.

Optionally, at least one of the elements comprising the cooling wall and the fixing plate has bracing bosses protruding on a face of said element which is turned towards the other element.

Optionally, at least some of the bracing bosses have a fixing area.

Optionally, the cooling wall has a planar surface against which the tube is pressed by the fixing plate.

Optionally, the fixing plate covers substantially the entire tube, particularly by covering at least 80% or even by covering 100% of the length of the tube.

Optionally, the at least one cooling wall forms part of a bottom wall of the holder.

The tube is a distinct element of the cooling wall as such. It is an element such as a pipe, of closed cross-section, added between the cooling wall and the fixing plate and held against the cooling wall by the fixing wall. The tube may be a rigid pipe made of thermally conductive material, particularly metal.

The fact that the coolant circulation tube is disposed between the cooling wall and the plate for fixing to this wall has several advantages. On the one hand, this makes it possible to limit losses in the cooling by the presence of the fixing plate opposite to this wall. Indeed, the fixing plate limits the heat exchange between the tube and the ambient air. On the other hand, this facilitates the mounting and the set-up of the coolant circulation tube, which can be sandwiched between the cooling wall and the fixing plate. Moreover, this gives great freedom in the fixing mode used, by adjusting the large surfaces available for the fixing between the cooling wall and the fixing plate. For example, fixing by welding, particularly spot welds, can be avoided which promotes the sustainability of the cooling system and its mechanical resistance.

### BRIEF DESCRIPTION OF THE DRAWINGS

The disclosure will be well understood and its advantages will appear better upon reading the following detailed description, of embodiments represented as non-limiting examples. The description refers to the appended drawings in which:

FIG. 1 shows in perspective a battery holder according to a first embodiment of the invention.

FIG. 2 is an exploded perspective view of the battery holder of FIG. 1.

FIG. 3 is a sectional view showing the fixing between the cooling wall and the fixing plate of the cooling system of this battery holder.

FIG. 4 shows a battery holder according to a second embodiment.

FIG. 5 is an exploded perspective view of the battery holder of FIG. 4.

FIG. 6 is a sectional view showing the fixing between the cooling wall and the fixing plate of the cooling system of the battery holder of FIG. 5.

FIG. 7 is a perspective view of a battery holder according to yet another embodiment.

FIG. 8 is an exploded perspective view of the battery holder of FIG. 7.

### DETAILED DESCRIPTION

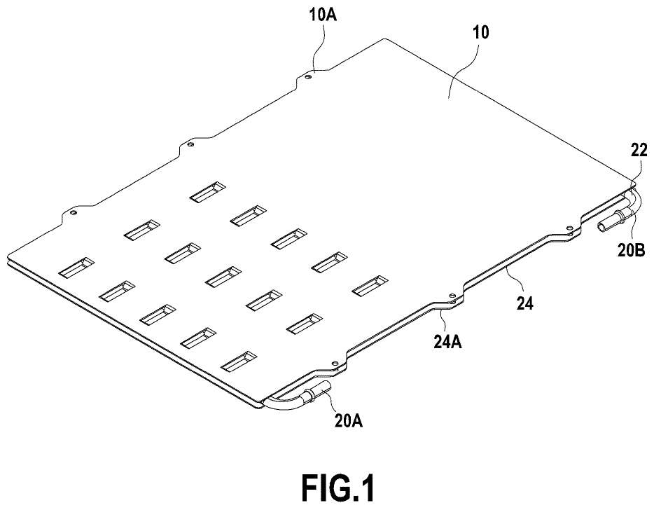

FIG. 1 shows a battery holder 1, which may particularly be a casing part containing or holding one or more battery units or cells. This holder comprises a cooling wall 10, for example a bottom wall on which the battery or the battery units can rest. The battery holder 1 may be fixed to an outer holder element, for example a chassis part of a vehicle.

In the example described here, it is considered that the cooling wall 10 is a bottom wall.

FIG. 1 shows this wall 10, in perspective taken from above. This FIG. 1 shows end pieces 20A and 20B serving to ensure the circulation of a coolant in a tube 22, the end pieces 20A and 20B serving respectively as an inlet and an outlet for the fluid. Particularly, this fluid may be water or another liquid.

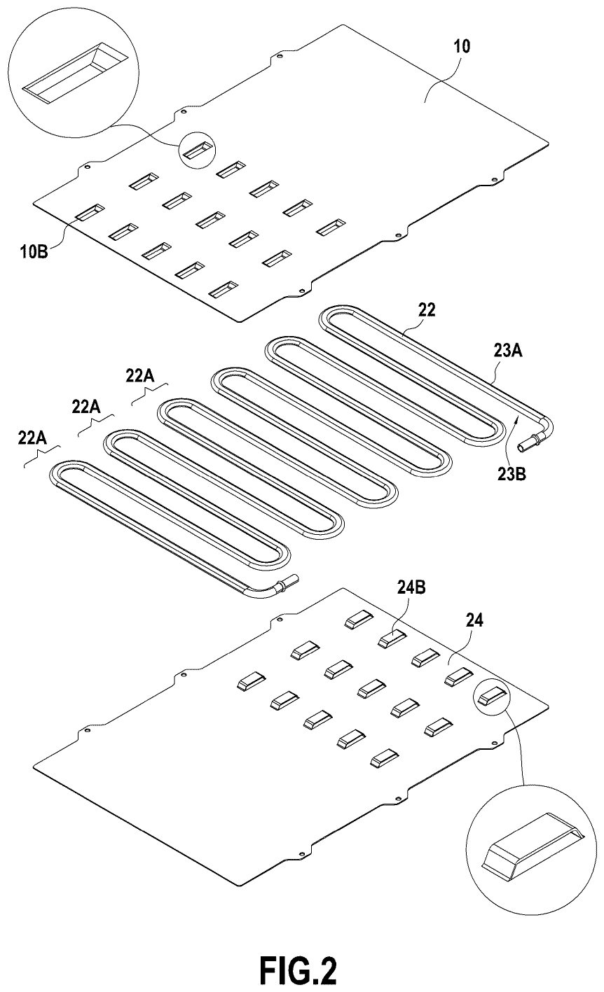

Also considering FIG. 2, it is understood that the tube 22 extends under the bottom wall 10 and that it is held against it using a fixing plate 24, so that the tube is sandwiched between the bottom wall 10 and the fixing plate 24. The cooling tube is therefore disposed between the bottom wall 10 and the fixing plate 24. This wall and this plate have in this case fixing lugs, respectively 10A and 24A, with drillings in register, these lugs projecting laterally relative to the tube 22. Optionally, these lugs make it possible, using bolts or the like, to consolidate the fixing between the wall 10 and the plate 24. They can also be used to fix the wall 10 and/or the plate 24 on an outer holder, such as a part of a vehicle.

The exploded view of FIG. 2 shows the cooling wall 10, the tube 22 and the bottom plate 24 detached from each other. The tube is shaped like a coil by forming loops 22A. It can be seen that the wall 10 and the plate 24 have reliefs for wedging the tube, respectively 10B and 24B. It is understood that these wedge reliefs are organized so as to be inserted into the loops 22A of the tube 22 when the latter is sandwiched between the wall 10 and the plate 24. In this case, the reliefs are organized in columns, their width corresponding to the inner width of the loops 22A themselves organized in adjacent columns. It could be imagined that only one of the two elements formed by the wall 10 and the plate 24 has such a relief, formed hollow from its outer wall so as to extend into the space between the wall 10 and the plate 24. However, in this case, the wall 10 and the plate 24 each comprise such reliefs, also formed hollow from their respective outer walls, but these reliefs are present only on a portion of the wall 10 or of the plate 24 corresponding substantially to half of this wall or of this plate. In fact, the wall 10 and the plate 24 can thus be formed by two identical elements which can be fixed together by placing their respective reliefs 10B or 24B not facing each other but on two distinct halves. In other words, the reliefs 10B of the wall 10 are then located opposite an area of the plate 24 which is devoid of reliefs 24B, and vice versa. Thus, once the wall 10 and the plate 24 are joined, the reliefs 10B and 24B form a complete set of wedge reliefs which can effectively wedge the tube between the wall 10 and the plate 24 from one edge to the other of this wall and of this plate. The reliefs 10B and 24B can be made by stamping.

Moreover, the tube 22 may have opposite faces, 23A, 23B, which are flattened, so as to be effectively pressed against the inner faces of the cooling wall 10 and of the fixing plate 24. Particularly, the part of the tube which is in contact with the inner face of the cooling wall 10 forms a contact face which is in heat exchanging contact with this cooling wall. The fact that this contact face is flattened maximizes the heat exchange surface between the cooling wall and the tube.

For its part, the fixing plate protects the tube on the outer side of the cooling system, in particular against impacts or risks of movement. In addition, it tends to confine the coolness of this tube in the interstitial space between the cooling wall 10 and the fixing plate 14, further promoting the cooling of the battery in contact with the cooling wall.

The fact that the tube is flattened on its two opposite faces allows, for a given section, maximizing the width of the tube, which increases its contact surface with the inner face of the cooling wall, against which faces of the batteries, for example their bottoms, are located.

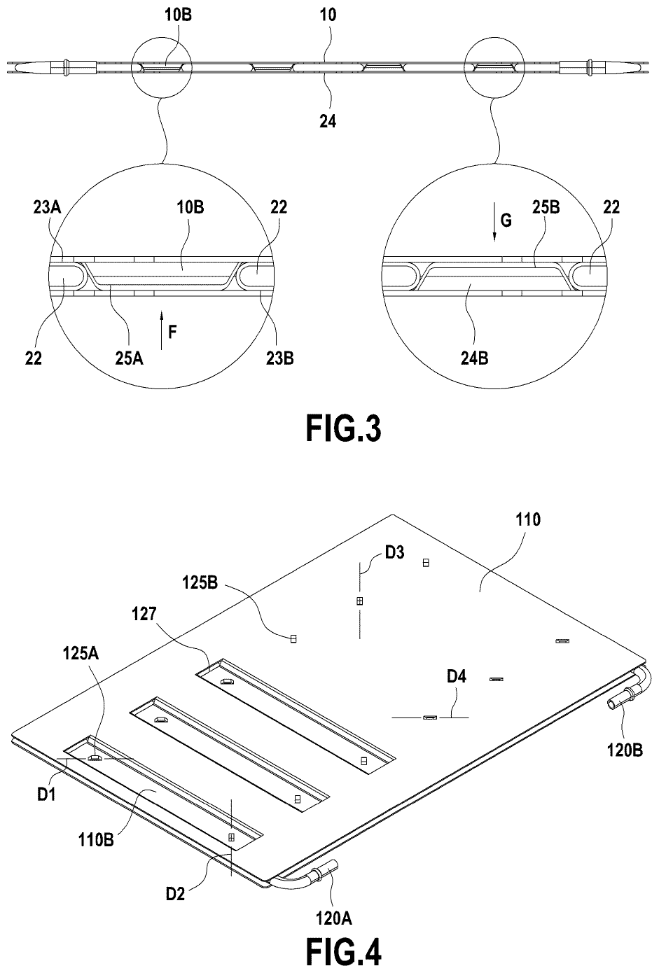

It has been mentioned that the wall 10 and the plate 24 can be fixed together by bolts passing through the drillings of their respective lugs 10A and 24A. This can serve as a safety fixing, on the edges of the wall and of the plate. However, it is also desirable that the wall and the plate are fixed together even in their current portions, away from their edges. In this respect, a fixing by welding could be envisaged. It is however interesting to carry out this fixing by clinching as shown in FIG. 3.

The cooling wall 10 and the fixing plate 24 can be particularly made of metal; it may be sheet pieces. The clinching between two pieces of this type consists, in areas where they are pressed against each other, in pushing them together using a punch, in a recess of a counter-tool. This results in a flow of the material of the two pieces pushed simultaneously, so that the two pieces remain closely connected. The clinching thus forms cups in which the two pieces are pushed together and in which the fixing is ensured in an extremely strong mechanical manner.

As shown in FIG. 3, the wedge reliefs can be used to perform the clinching. Indeed, clinching can for example be performed in the bottom of a wedge relief 10B of the cooling wall 10, as shown in the left-hand enlargement of FIG. 3. In this area, the inner face of the wedge relief 10B (this inner face being the one turned towards the plate 24) comes substantially into contact with the inner face of the fixing plate 24. Using a punch applied from below the fixing plate, the latter can be locally pushed, with the bottom of the wedge relief, in the direction going towards the cooling wall 10, as shown by the arrow F. This creates a small clinching cup on the outer face of the fixing plate 24, this cup forms a boss on the outer face of the wedge relief 10B. Thus, the wedge relief 10B performs its function of wedging the tube 22 by being housed in a loop 22A of this tube, and also serves for the fixing by clinching between the wall 10 and the plate 24. Similarly, in the enlarged right-hand part of FIG. 3, it can be seen that the clinching has been carried out in the wedge relief 24B of the fixing plate, by pushing, in the direction of the arrow G, part of the wall 10 in contact with this wedge relief towards the fixing plate. Thus, this creates a small clinching cup forming a boss in the outer face of the cooling wall 24. It is possible to choose to carry out a clinching in all the wedge reliefs or in some of them. Generally, it is not necessary for the clinching to be formed in extremely numerous areas, but it is desirable to distribute them over the surfaces of the wall 10 and of the fixing plate 24. Thus, the clinching areas could be made in part of the wedge reliefs, for example in 10% to 50% of these reliefs. In what has just been described, the clinching areas are made in the wedge reliefs by taking advantage of the fact that, in these reliefs, the inner faces of the wall 10 and of the plate 24 are naturally close to each other. However, it would be possible, instead or in addition, to make the clinching areas in other areas of the wall 10 and of the plate 24, these other areas not being used, moreover, for wedging the tube 22.

With reference to FIGS. 4 to 6, another embodiment is now described. In these figures, the elements corresponding to those of the previous figures are designated by the same references, increased by 100. The cooling plate 110, the coolant circulation tube 122 with its end pieces 120A and 120B, and the fixing plate 124 are therefore identified. As in the previous embodiment, wedge reliefs are provided. These are, on the one hand, wedge reliefs 110B, formed hollow from the outer face of the cooling wall and, on the other hand, wedge reliefs 124B formed hollow from the outer face of the fixing plate 124. These wedge reliefs form elongated bosses which, in the example represented, extend over a significant part of the length of the loops 122A formed by the coil of the tube 122, of the order of 80% of the length of these loops. Thus, whereas in the previous embodiment, several wedge reliefs, of reduced length (the length being measured in the lengthwise direction of the loop), were present in the loops 22A of the tube, the present embodiment uses fewer wedge reliefs (for example a single relief in a given loop) but of greater length. It is possible to provide that the wedge reliefs 110B and 124B extend over 20% to 90% of the length of the loops 122A, for example over 40% to 80% of this length, and one or two wedge reliefs can be provided for a loop. The reliefs 110B and 124B can be made by stamping.

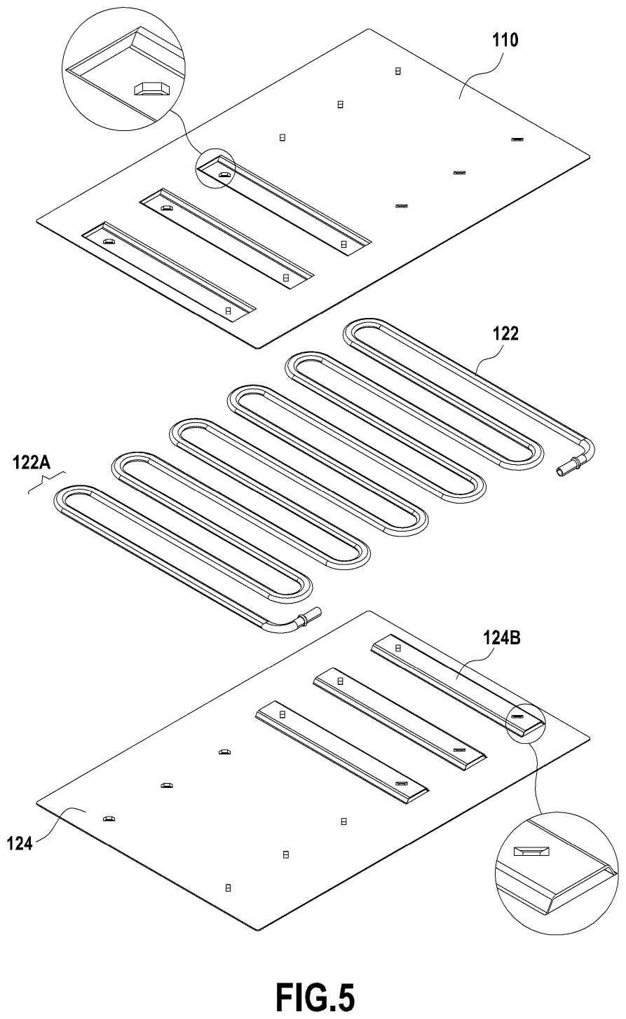

As in the previous embodiment, the cooling wall 110 and the fixing plate 124 are fixed together by clinching. The clinching areas are represented in FIGS. 4 and 5. It can be seen that they are distributed over the fixing reliefs.

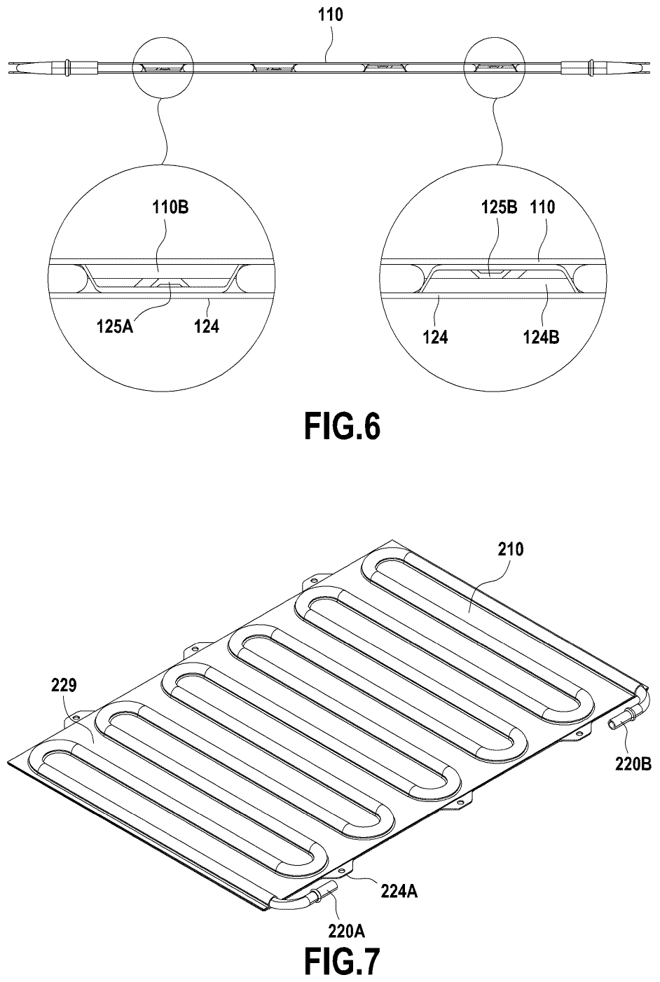

FIG. 6, which is a view similar to FIG. 3 for this second embodiment, thus shows a clinching cup formed hollow from the outer face of the fixing plate 124 so as to form a boss 125A protruding on the outer face (in the bottom) of the wedge relief 110B. Similarly, the enlarged right-hand part of FIG. 6 shows a clinching cup 125B formed hollow in the outer face of the cooling wall 110 so as to form a boss that extends into the bottom of the outer face of the wedge relief 124B of the fixing plate 124. It can be seen here that the clinching cups 125A and 125B, also identified in FIG. 4, are made by forming angles together. Of course, these cups could be isometric and have general shapes of revolution. However, it has been chosen here to make them in the form of cups elongated in one direction and it can thus be seen that some clinching cups 125A are elongated in a direction D1 while others are elongated in a direction D2. The same applies to the clinching cups 125B which are elongated either in a direction D3 (which in this case can be the same as the direction D2) or in the direction D4 (which in this case can be the same as the direction D1). The inventors have found that this promotes the mechanical resistance of the clinching between the cooling wall and the fixing plate in different directions.

The fact of thus orienting the clinching cups in different directions makes it possible to maximize their overall mechanical resistance to shear stresses, regardless of the direction of application of these stresses.

In the embodiments just described, the wedge reliefs extend into the space formed in the loops 22A or 122A of the cooling tube. In practice, the wedge relief formed in one of the elements comprising the cooling wall 10 and the fixing plate 24 extends toward the other element until it comes into contact with the inner face of this other element.

Thus, the wedge reliefs form in this case bracing bosses which ensure the desired spacing between the cooling wall and the fixing plate so as to house the tube 22 or 122 between these elements by ensuring the desired contact surfaces between the tube and the cooling wall, but by ensuring that the cooling wall and the fixing plate mechanically protect the tube against impacts and the risk of crushing.

This makes it possible in particular to make the tube in a material that is less mechanically resistant than that of the cooling wall and of the fixing plate. The tube can be made of metal, for example steel or aluminum. For reasons of economy, a tube with a thin wall can be used, since protection against impacts is ensured elsewhere. It can be chosen to make the tube from another material, for example a synthetic material, in particular a thermoplastic polymer of the type used in the cooling circuits used to cool automotive engines.

The elements 10B, 24B, 110B, 124B that have just been described therefore fulfill the dual function of wedge reliefs for the tube and of bracing bosses between the cooling wall and the fixing plate. Their function as wedge reliefs is ensured by the fact that they are inserted into the loops formed by the coil of the coolant circulation tube, by having dimensions that allow wedging these loops against their edges. Their function as bracing bosses is related to the fact that their depth or their thickness, measured in the direction of the spacing between the wall and the plate, is determined so as to define the thickness of the interstitial space formed between the cooling wall and the fixing plate. These two functions could of course be dissociated by having, on the one hand, wedge reliefs that do not necessarily come into contact with the face opposite the wall or the plate and, on the other hand, bracing bosses.

In this case, at least some of the bracing bosses (which are also wedge reliefs in this case) have a fixing area, allowing in this case a fixing by clinching.

In the examples just described, the cooling wall 10 or 110 has an inner planar surface against which the tube is pressed by the fixing plate 24 or 124. In this case, the fixing plate 24 or 124 covers substantially the entire tube 22 or 122. It can be seen in this case that, apart from the end pieces 20A, 20B or 120A, 120B, the tube does not project from the cooling wall of the fixing plate. These two elements, cooling wall and fixing plate, are in this case formed by solid or substantially solid elements, with the exception of any slots made at the end of the fixing reliefs, as indicated by the reference 127 in FIG. 4. This makes it possible to optimize the exchange surfaces and the cooling of the cooling wall by means of the tube. However, it could be provided that one of these elements is perforated, particularly the fixing plate. In this case, the fixing plate 24 or 124 covers substantially the entire tube, by covering at least 80%, or even 100% of its length. However, it could be provided that the fixing plate covers only a smaller portion of the length of the tube.

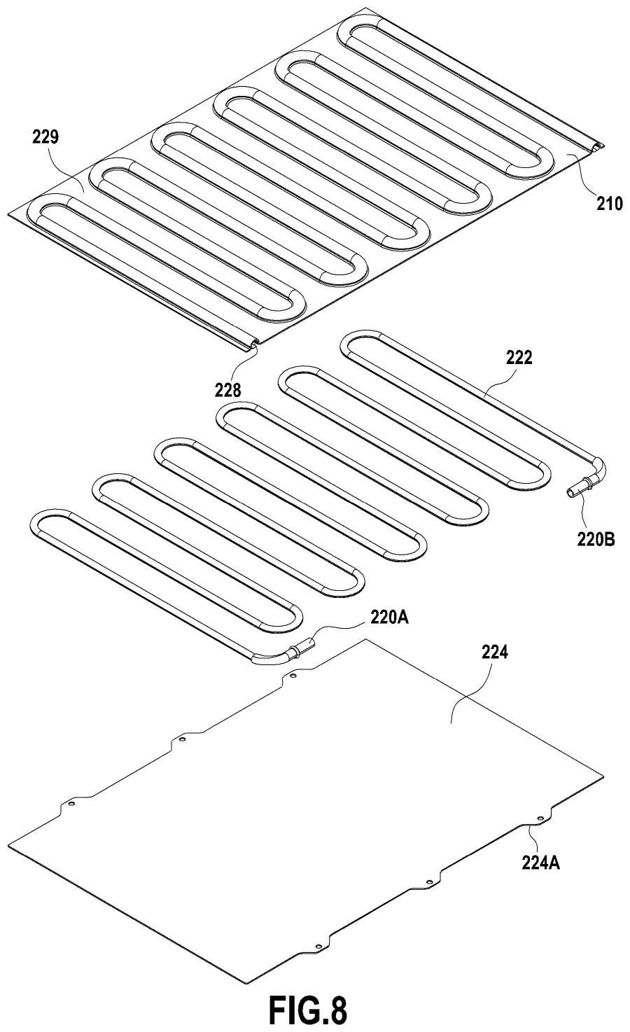

With reference to FIGS. 7 and 8, another embodiment is now described. In these figures, the elements corresponding to those of the preceding figures are designated by the same references as in FIGS. 1 to 3, increased by 200. The cooling system thus represented in FIGS. 7 and 8 comprises a cooling wall 210 and a fixing plate 224, between which a coolant circulation tube 222 is sandwiched, this tube having inlet and outlet end pieces 220A and 220B for the coolant. Fixing lugs 224A may be provided on the fixing plate 224, for example to fix the assembly formed by the cooling system comprising the cooling wall 210, the tube 222 and this plate 224, to another element, such as another wall of the battery holder, or part of the vehicle chassis. Of course, the cooling wall 210 could have fixing lugs in correspondence with the lugs 224A, as was the case in the embodiment of FIGS. 1 to 4. As in the previous figures, the fixing wall 224 covers practically the entire length of the tube, with the exception of the end pieces 220A and 220B.

What distinguishes this embodiment from the previous ones is the fact that the cooling wall 210 comprises a groove 228 for receiving the tube 222. This groove can particularly be made by stamping. In this case, this groove 228 forms a coil, made hollow on the inner face of the cooling wall 210, this coil receiving the coil of the tube 222. Thus, in these areas 229 located between the coil loops formed by the groove 228, the cooling wall 210 can be pressed against the fixing plate 224. Of course, it would be possible to provide for an inverse embodiment, by forming the groove in the inner face of the fixing plate, or for a mixed embodiment, by forming the groove partly (for example over half of its depth) in the cooling wall and, for its remaining part, in the fixing plate. In all cases, the groove or the groove parts can be made by stamping.

The cooling wall 10 and the fixing plate can be fixed together in these areas, particularly by clinching cups similar to those described in the preceding figures, these cups being able in particular to be oriented in different directions.

In the various embodiments that have just been described, the fixing plate is fixed to the cooling wall in several fixing areas in which this plate and this wall are in contact. These fixing areas can be located in the wedge reliefs or in the bracing bosses as has been described or generally in contact areas between the cooling wall and the fixing plate.

In the examples that have just been described, the cooling wall and the fixing plate cover the tube over practically its entire length, and in particular over all of the loops formed by its coil. Generally, these loops comprise rectilinear segments, between which the wedge reliefs may in particular be disposed when these reliefs are provided, and also rounded connection segments, connecting the adjacent rectilinear segments together.

For reasons of simplicity of manufacture, it could possibly be provided that the cooling wall and/or the fixing plate do(es) not cover these curved connection segments. This may in particular be the case for the embodiment of FIGS. 7 and 8, so as to simplify the conformation of the groove 228, particularly if the latter is formed, not in the cooling wall 210 as in the drawings, but rather in the fixing plate 224. In this case, this fixing plate could stop at the junction between the rectilinear parts and the curved parts of the cooling tube.

The invention claimed is:

1. A battery holder comprising a cooling system that comprises at least a cooling wall and a tube for circulating a coolant, the tube being held against the cooling wall by being disposed between the cooling wall and a fixing plate fixed to the cooling wall.

2. The battery holder according to claim 1 wherein the fixing plate is fixed to the cooling wall by clinching.

3. The battery holder according to claim 1, wherein the tube has at least one flattened face turned towards the cooling wall.

4. The battery holder according to claim 1, wherein the tube has at least one contact face (23A), in heat exchanging contact with the cooling wall.

5. The battery holder according to claim 1, wherein at least one of the elements comprising the cooling wall and the fixing plate has a relief for wedging the tube.

6. The battery holder according to claim 1, wherein at least one of the elements comprising the cooling wall and the fixing plate has at least one groove for receiving the tube.

7. The battery holder according to claim 1, wherein the fixing plate is fixed to the cooling wall in several fixing areas in which the fixing plate and the cooling wall are in contact.

8. The battery holder according to claim 1, wherein at least one of the elements comprising the cooling wall and the fixing plate has bracing bosses protruding on a face of said element which is turned towards the other one of the elements comprising the cooling wall and the fixing plate.

9. The battery holder according to claim 8, wherein at least some of the bracing bosses have a fixing area.

10. The battery holder according to claim 1, wherein the cooling wall has a planar surface against which the tube is pressed by the fixing plate.

11. The battery holder according to claim 1, wherein the cooling wall forms part of a bottom wall of the holder.

12. The battery holder according to claim 1, wherein the tube has a flattened face turned towards the fixing plate.

13. The battery holder according to claim 4, wherein the contact face is a flattened face.

14. The battery holder according to claim 7, wherein the fixing areas comprise fixing areas located between portions of the tube.
